(19) United States
(12) Patent Application Publication
(10) Pub. No.: US 2010/0040880 A1
(43) Pub. Date: Feb. 18, 2010

(54) PROCESS FOR FABRICATING PEPTIDE-COATED FIBERS

(76) Inventors: Rudolf J. Koopmans, Einsiedeln (CH); Amalia Aggeli, Leeds (GB); Eileen Ingham, Leeds (GB)

Correspondence Address: The Dow Chemical Company, Intellectual Property Section, P.O. Box 1967, Midland, MI, 48641-1967, US

(21) Appl. No.: 12/539,810

(22) Filed: Aug. 12, 2009

Related U.S. Application Data
(60) Provisional application No. 61/088,529, filed on Aug. 13, 2008.

(51) Int. Cl. B32B 27/34; B05D 1/18; B32B 27/02

(52) U.S. Cl. 428/395; 427/434.6; 428/394

(57) ABSTRACT

The present invention generally relates to peptide-coated fibers, processes of fabricating said fibers, and articles incorporating said fibers.

### CROSS-REFERENCE TO RELATED APPLICATION(S)

This application claims benefit of priority from U.S. Provisional Patent Application No. 61/088,529, filed Aug. 13, 2008, which application is incorporated by reference herein in its entirety.

The present invention generally relates to peptide-coated fibers, processes of fabricating said fibers, and articles incorporating said fibers.

### INCORPORATION-BY-REFERENCE OF MATERIAL SUBMITTED ELECTRONICALLY

Applicants submit herewith a Sequence Listing in both paper (as .pdf file) and computer readable (as .txt file) format electronically using EFS-Web 1.1, accompanied by statement required 37 C.F.R. §§1.821-1.825. Sequence listing information recorded in computer readable (as .txt file) format is identical to sequence listing information in the paper (as .pdf file) format. If necessary to comply with 37 C.F.R. §§1.821-1.825, the material in the computer readable (as .txt file) format is incorporated herein by reference.

### BACKGROUND OF THE INVENTION

New peptide-coated fibers are needed for applications where the peptide may add a beneficial function to, or beneficially modify a function of, the fibers, including applications where the fibers deliver the peptide to a site in need of a beneficial peptide activity. For example, fibers coated with a sequestering peptide are sought for catalyst support and air and liquid filtration applications among others. Fibers coated with an anti-infective peptide are of interest for wound care, personal hygiene, filtration, and cleaning applications for instance. Preferably, such peptide-coated fibers are reusable. For example, anti-infective peptide-coated fibers are needed that may release from the coated fibers in response to a coating trigger, kill infectious organisms at a site in need of anti-infective activity, and then re-coat the fibers in response to another coating trigger to give recoated anti-infective peptide-coated fibers.

### SUMMARY OF THE INVENTION

The present invention provides peptide-coated fibers, processes of fabricating said fibers, and articles incorporating said fibers.

In a first embodiment, the present invention is a process of fabricating a peptide-coated fiber, the process comprising the steps of: (a) contacting a coating-receptive fiber that has a diameter of 10 micrometers (em) or less to a medium comprising at least one self-assembled peptide polymer and a peptide-coating solvent, wherein the at least one self-assembled peptide polymer is dissolved in the peptide-coating solvent and contacts said coating-receptive fiber, wherein each self-assembled peptide polymer independently comprises two or more self-assembling peptides and each self-assembling peptide is the same or different and independently comprises a self-assembly segment of from 2 to 59 amino acid residues; and (b) allowing the at least one self-assembled peptide polymer to at least partially coat the coating-receptive fiber; wherein the process produces at least one peptide-coated fiber comprising the coating-receptive fiber and a peptide coating, the peptide coating comprising the at least one self-assembled peptide polymer and being in reversible operative coating contact with the coating-receptive fiber. In some embodiments, at least one, preferably each self-assembling peptide independently further comprises one or two supplemental segments, each supplemental segment independently comprising 1 or more amino acid residues. Preferably, the supplemental segments are absent. When the one or two supplemental segments are present, preferably each supplemental segment independently comprises residuals from a protein expression of the self-assembling peptide. Preferably the contacting step is allowed to proceed for a time (e.g., 1 hour) sufficient for at least partially coating the coating-receptive fiber. In some embodiments, the process further comprises a drying step of removing a substantial portion of the peptide-coating solvent from the peptide-coated fiber.

In a second embodiment, the present invention is a peptide-coated fiber comprising a coating-receptive fiber and a peptide coating, the peptide coating being in reversible operative coating contact with the coating-receptive fiber; wherein the coating-receptive fiber has a diameter of 10 micrometers (em) or less and the peptide coating comprises at least one self-assembled peptide polymer, wherein each self-assembled peptide polymer comprises two or more self-assembling peptides and each self-assembling peptide is the same or different and independently comprises a self-assembly segment of from 2 to 59 amino acid residues and, optionally, one or two supplemental segments each independently comprising 1 or more amino acid residues. Preferably, the supplemental segments are absent. When one or two supplemental segments are present, preferably each supplemental segment independently comprises residuals from a protein expression of the self-assembling peptide. Preferably, the coating-receptive fiber has a diameter of 5 μm or less, more preferably less than 1000 nanometers (nm). In some embodiments, said peptide-coated fiber comprises a single layer coating comprising one or more self-assembled peptide polymers. In other embodiments, said peptide-coated fiber comprises two or more layer coatings independently comprising same or different self-assembled peptide polymers.

In a third embodiment, the present invention is an article comprised of at least one peptide-coated fiber of the second embodiment.

### BRIEF DESCRIPTION OF THE DRAWINGS

FIG. 1 plots percent beta-sheet (β-sheet) form of a self-assembling peptide of SEQ ID NO: 11 as a function of pD of a solution in deuterium oxide (D₂O) in the absence of added salt.

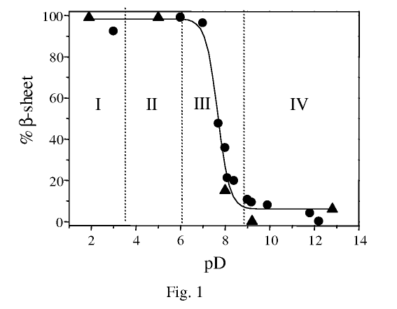

FIG. 2 plots percent P-sheet form of a self-assembling peptide of SEQ ID NO: 11 as a function of pD of a sodium chloride (NaCl) solution in D₂O.

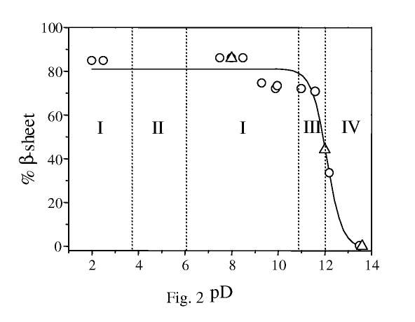

FIGS. 3A and 3B respectively are scanning electron microscope (SEM) images of an interior portion of uncoated fiber(s) of a control sample of Coating-Receptive Fiber Preparation 1 as a non-woven fabric and an interior portion of a non-woven fabric comprised of the peptide-coated MSA poly(ester-amide) fiber(s).

FIGS. 4A and 4B respectively are SEM images of an interior portion of uncoated fiber(s) of a control sample of Coating-Receptive Fiber Preparation 1 as a non-woven fabric and an interior portion of a non-woven fabric comprised of peptide-coated fiber(s) of Example 1 after being washed with water for 1 hour.

FIGS. 5A and 5B respectively are SEM images, at different magnifications, of an interior portion of a non-woven fabric comprised of peptide-coated fiber(s) of Example 1 after being washed for one week with a solution of NaCl in water.

FIGS. 6A to 6D depict generic representations of self-assembled peptide polymers useful in the present invention.

### DETAILED DESCRIPTION OF THE INVENTION

The present invention provides peptide-coated fibers, processes of fabricating said fibers, and articles comprising one or more said fibers. Preferably, the peptide-coated fiber of the first embodiment comprises a woven material or, more preferably, a non-woven material, e.g., a non-woven mat.

For purposes of United States patent practice and other patent practices allowing incorporation of subject matter by reference, and the entire contents—unless otherwise indicated—of each U.S. patent, U.S. patent application, U.S. patent application publication, PCT international patent application and WO publication equivalent thereof, referenced in the instant Detailed Description of the Invention are hereby incorporated by reference. In an event where there is a conflict between what is written in the present specification and what is written in a patent, patent application, or patent application publication, or a portion thereof that is incorporated by reference, what is written in the present specification controls.

In the present application, any lower limit of a range, or any preferred lower limit of the range, may be combined with any upper limit of the range, or any preferred upper limit of the range, to define a preferred embodiment of the range.

In an event where there is a conflict between a value given in a U.S. unit (e.g., millimeters of mercury) and a value given in a standard international unit (e.g., kilopascals), the U.S. unit value controls.

In any embodiment described herein, the open-ended terms “comprising,” “comprises,” and the like (which are synonymous with “including,” “having,” and “characterized by”) may be replaced by the respective partially closed phrases “consisting essentially of,” consists essentially of,” and the like or the respective closed phrases “consisting of,” “consists of,” and the like.

### Materials Comprising Coating-Receptive Fibers

A coating-receptive fiber useful in the present invention means a filament, including a fibril, having a diameter of 10 μm or less that is capable of receiving a peptide-coating comprising a self-assembled peptide polymer. Without being bound by theory, a fiber capable of receiving a peptide coating is of a diameter small enough so that the self-assembled peptide polymer is physically at least partially wrapped around the coating-receptive fiber (as described below), comprises chemical functional groups that interact with functional groups of the self-assembled peptide polymer as described below for “operative coating contact,” or, preferably, a combination thereof.

A coating-receptive fiber useful in the present invention comprises a naturally occurring organic material that is cotton, silk, cellulose, wool, or starch, an altered naturally occurring organic material (e.g., rayon), or, preferably, a man-made material. The man-made material preferably comprises carbon nanotubes, an organic polymer material, glass, or inorganic material that can be drawn into a filament (e.g., gold, silver, and titanium). More preferably, the man-made material comprises an organic polymer material. Examples of preferred organic polymer materials are polyolefins such as polypropylene; polyesters such as poly(ethylene terephthalate) and poly(butylene terephthalate); polyamides such as nylon-6,6; poly(ester-amides); poly(ether-amides); poly(ester-ureas); poly(ether-ureas); poly(ester-urethanes); and poly(ether-urethanes). Examples of other preferred organic polymer materials are polycaprolactone; a copolymer comprising a polycaprolactone; poly(glycolic acid); a copolymer comprising a poly(glycolic acid); nylon-6,6; polyurethane; poly(benzimidazole); polycarbonate; poly(acrylonitrile); poly(vinyl alcohol); poly(lactic acid); a copolymer comprising poly(lactic acid); poly(ethylene-co-vinyl acetate); poly(ethylene-co-vinyl acetate)/polylactic acid; poly(methacrylate)/(tetrahydroperfluorooctylacrylate); poly(ethylene oxide); collagen-poly(ethylene oxide); poly(aniline)/poly(ethylene oxide) blend; poly(aniline)/poly(styrene); silk-like polymer with fibronectin functionality; poly(vinylcarbazole); poly(acrylic acid)-poly(pyrene methanol); poly(styrene); poly(methacrylate); silk/poly(ethylene oxide) blend; poly(vinyl phenol); poly(vinyl chloride); cellulose acetate; a mixture of poly(acrylic acid)-poly(pyrene methanol) and polyurethane; and poly(vinyl alcohol)/silica.

In some embodiments, the coating-receptive fibers (e.g., poly(ester-amide), poly(ether-amide), poly(ester-urea), poly(ether-urea), poly(ester-urethane), and poly(ether-urethane)) comprises a molecularly self-assembling (MSA) material. Examples of MSA materials useful in the present invention are poly(ester-amides), poly(ether-amides), poly(ester-ureas), poly(ether-ureas), poly(ester-urethanes), and poly(ether-urethanes), and mixtures thereof that are described in U.S. Pat. No. 6,172,167, which is incorporated herein in its entirety by reference; and applicant's co-pending PCT application numbers PCT/US2006/023450, which was renumbered as PCT/US2006/004005 and published under PCT International Patent Application Number (PCT-IPAPN) WO 2007/099397; PCT/US2006/035201, which published under PCT-IPAPN WO 2007/030791; PCT/US08/053917; PCT/US08/056754; and PCT/US08/065242, each of which, or its United States Patent Application Publication number (USPAPN) family member when available, is incorporated herein in its entirety by reference. Preferably, the coating-receptive fibers do not comprise a MSA material.

In some embodiments, the polymers described herein are modified with, for example and without limitation thereto, other polymers, resins, tackifiers, fillers, oils and additives (e.g. flame retardants, antioxidants, processing aids, pigments, dyes, and the like).

### Fabricating Coating-Receptive Fibers

Coating-Receptive Fibers are fabricated by any known method including, for example, solution spinning, fiber drawing, textile spinning, spun bonding, electrospinning (e.g., solution or melt electrospinning), electroblowing, and melt blowing. In some embodiments, processing conditions for these methods are adjusted to produce coating-receptive fibers, without beading, of different average diameters including submicron average-diameter coating-receptive fibers. In some embodiments, Coating-Receptive Fibers are produced at elevated temperatures, allowing for production of aseptic coating-receptive fibers (i.e., coating-receptive fibers that are essentially free of living microorganisms).

Devices for fabricating fibers include electrospinning devices, melt blowing devices, melt extruding devices, and the like. Preferably, such devices include one or more collectors for collecting the fibers. Examples of suitable collectors are webs, foils, films, papers, fabrics, wovens, and nonwovens. Collectors may comprise inorganic or organic materials such as, for example, wood or, preferably glass, polymers, metals, papers ceramics, and combinations thereof. In some embodiments of the present invention, a collector comprises a non-woven web scaffolding useful in medical applications (e.g., as a bandage). Some embodiments employ two or more collectors, each collector collecting at least one peptide-coated fiber.

The general technique of electrospinning of coating-receptive fiber-forming materials is known and has been described in a number of patents and the general literature. A typical electrospinning apparatus for use in preferred embodiments of the present invention includes three primary components: a high voltage power supply, a spinneret, and a conductor (e.g., a grounded conductor or charged conductor). In particular, the charged conductor may have a polarity opposite to the polarity of the spinneret (e.g., spinneret may have positive charge and charged conductor may have negative charge). Preferably, such an electrospinning apparatus further includes one or more collectors. Collectors for electrospinning are grounded or ungrounded. Preferably, the apparatus further includes an ungrounded collector that is placed in front of the conductor and optionally is or is not in physical contact therewith.

The spinneret is a spin electrode that allows for extracting fibers by way of an electric field. In some embodiments, the spinneret is a syringe, a cylinder (e.g., a cylinder rotating in a solution), screen, wire, a capillary device, or a conductive surface that is connected to a feeding system for introducing a material (e.g., a solution or melt) of the fiber forming material, and optionally is or is not heated and does or does not include hot air jets. A preferred system uses a pump to control the flow of the material out of, for example, a syringe nozzle allowing the material to form a Taylor cone.

Preferably, the electrospinning device comprises at least one electrode (e.g., spinneret or cylinder), at least one conductor (e.g., a grounded conductor or a conductor charged with opposite polarity compared to polarity of a charge of the electrode), a source of voltage (e.g., a power supply), and, optionally, a collector, wherein the electrode(s) independently is in operative electricity communication with the source of voltage and with the conductor. In typical operation of the device, the electrode is in physical contact with the solution or melt of the material, which solution or melt preferably is in operative fluid communication between a source thereof and the electrode. Preferably, the process further comprises a step of collecting the fibers on a grounded conductor or, more preferably, on a collector. The collector may or may not be grounded and may or may not be charged with opposite polarity compared to polarity of a charge of an electrode of the electrospinning device.

Preferred electrospinning devices are those that are marketed commercially as being useful for electrospinning. Use of commercially available electrospinning devices, such as those available from NanoStatics™, LLC, Circleville, Ohio, USA; and Elmarco s.r.o., Liberec, Czech Republic (e.g., using Nanospider™ technology), are more preferred.

Conditions for electrospinning the aforementioned other preferred organic polymer materials are known (see, for example, table 1 of Huang Z. M., et al., Composite Science and Technology, 2003; 63:2223-2253 and references cited therein).

A melt blowing device typically comprises at least one die block having a portion that functions as a die tip; at least one gas knife assembly; a source of a stretch gas stream; and a collector, wherein the source of a stretch gas stream independently is in operative fluid communication with the gas knife assembly and the die tip. The die tip defines at least one, preferably a plurality of, apertures through which a melt of a material to be melt blown passes. A source of the melt is in operative fluid communication with the apertures of the die tip. Examples of useful stretch gases are air, nitrogen, argon, helium, and a mixture of any two or more thereof. Preferably, the stretch gas is air, nitrogen, or a mixture thereof; more preferably the stretch gas is air. An example of a melt blowing device is an Oerlikon Neumag Meltblown Technology™ system (Oerlikon Heberlein Wattwil AG, Switzerland).

### Producing Coating-Receptive Fibers Comprising Fiber-Forming Materials by Solution Electrospinning

Preferred fiber-forming materials useful in the present invention are solution electrospun into fibers, including submicron diameter fibers, by feeding a solution thereof into or onto the spinneret from, for example, a syringe at a constant and controlled rate using a metering pump. A high voltage (1 kilovolt (kV) to 120 kV, preferably 1 kV to 100 kV, and more preferably 1 kV to 50 kV) is applied and a portion of the solution, preferably in the form of a droplet, at the nozzle (e.g., needle) of the syringe becomes highly electrified. At a characteristic voltage the portion (e.g., droplet) forms one or more Taylor cones, and a fine jet, in some embodiments two or more such jets, of fiber-forming material develops. The fine fiber-forming material jet is drawn towards the grounded conductor which is placed opposing the spinneret. While being drawn towards the grounded conductor, the solution-electrospinning solvent at least partially dissipates (e.g., at least partially phase separates, evaporates, or a combination thereof) and the jet solidifies into fibers. Preferably, the solution-electrospinning solvent is substantially completely dissipated (i.e., lost) from the fibers. Substantially complete dissipation of the solvent from the fibers (e.g., loss of at least 95 wt %, more preferably at least 99 wt % of the solvent from the fibers) may occur before, during, or after the fibers are deposited and may comprise part of a solution electrospinning unit operation or a separate unit operation (e.g., a drying operation that may or may not be in direct communication with the solution electrospinning unit operation). Preferably, the fibers are deposited on a collector that is placed in front of the conductor. In some embodiments, fibers are deposited on the collector as a randomly oriented, non-woven mat or individually captured and wound-up on a roll. The fibers are subsequently stripped from the collector if desired. In other embodiments, a charged conductor (opposite polarity to that of electrode) is employed instead of the grounded conductor.

The parameters for operating the electrospinning apparatus may be readily determined by a person of ordinary skill in the art without undue experimentation. By way of example, the spinneret is operated at about 20° C. or ambient temperature, the spin electrode is maintained at the same temperature or temperature at which the fiber-forming material has sufficiently low viscosity to allow thin fiber formation. If desired, the spinneret is generally heated up to about 300° C. and the surrounding environmental temperature optionally is maintained at about similar temperatures using hot air. Alternatively, the spinneret is generally heated up to about 300° C. and the surrounding environmental temperature optionally is maintained at about room temperature (i.e., from about 20° C. to 30° C.). The applied voltage is generally about 1 kV to 120 kV, preferably about 1 kV to 100 kV, more preferably 1 kV to 50 kV. The electrode gap (the gap between spin electrode and conductor) is generally between about 3 centimeters (cm) and about 50 cm, preferably between about 3 cm and about 40 cm. Preferably, the fibers are fabricated at about ambient pressure (e.g., 1.0 atmosphere), although the pressure may be higher or lower depending upon the particular operating conditions employed such as solvent(s), concentrations of solutions of fiber-forming materials, and temperatures. Preferred electrospinning devices are those that are marketed commercially as being useful for solution electrospinning. Use of commercially available solution electrospinning devices, such as those available from NanoStatics™, LLC, Circleville, Ohio, USA; and Elmarco s.r.o., Liberec, Czech Republic (e.g., using Nanospider™ technology), are more preferred.

Various solvents are used in a solution electrospinning process. A preferred solution-electrospinning solvent is (monohalo to perhalo)(C₁-C₆)alkyl; R¹C(O)OR²; R¹C(O)NR³R⁴; R³OR⁴; R⁵C(O)R⁶; or a mixture thereof, wherein each halo independently is fluoro or chloro, each R¹ and R² independently is H or (C₁-C₃)alkyl, each R³ and R⁴ independently is H or (C₁-C₃)alkyl or R³ and R⁴ taken together form a (C₂-C₆)alkylene, and each R⁵ and R⁶ independently is (C₁-C₃)alkyl or R⁵ and R⁶ taken together form a (C₂-C₆)alkylene. A more preferred solvent is chloroform, methanol, water, formic acid, alcohols (e.g., R³OR⁴ wherein R³ is (C₁-C₃)alkyl and R⁴ is H), N,N-dimethylformamide, tetrahydrofuran, 1,2-dichloroethane, ethyl acetate, methylethylketone, or mixtures thereof. Still more preferred are chloroform and formic acid.

For electrospinning solvents, the term “(C₁-C₃)alkyl” means methyl, ethyl, 1-propyl, or 2-propyl. The term “(C₂-C₆)alkylene” means a straight or branched hydrocarbon diradical of 2 to 6 carbon atoms. The (C₁-C₃)alkyl and (C₂-C₆)alkylene independently are unsubstituted or substituted with one or more substituents halides, alkoxy groups (e.g., (C₁-C₃)alkoxy), hydroxy, thiol (i.e., —SH), carboxylic ester groups (e.g., —C(O)OR²), ketone groups (e.g., —C(O)R⁶;), carboxylic acid (i.e., —COOH), amines (e.g., —NR³R⁴), and amides (e.g., —C(O)NR³R⁴), wherein R², R³, R⁴, and R⁶ are unsubstituted versions of the groups as defined herein for the electrospinning solvents.

In some embodiments, a surfactant, salt, and other material is added to the electrospinning solution to modify one or more of the operating characteristics (e.g., viscosity, conductivity (or resistivity), and surface tension) of the solution. These additives include, but are not limited to, sodium dodecyl sulfate, pyridinium formate, inorganic salt, poly(ethylene glycol), triethyl benzyl ammonium chloride, aliphatic poly(propylene oxide)-poly(ethylene oxide) ether, nanoclay (laponite) and combinations thereof.

### Producing Coating-Receptive Fibers Comprising Fiber-Forming Materials by Melt Electrospinning

In a typical melt electrospinning process for producing coating-receptive fibers comprising a fiber-forming material, the material in melted form is fed into or onto the spinneret from, for example, the syringe at a constant and controlled rate using a metering pump. A high voltage (e.g., 1 kV to 120 kV) is applied and the drop of fiber-forming material at the nozzle of the syringe becomes highly electrified. At a characteristic voltage the droplet forms a Taylor cone, and a fine jet of fiber-forming material develops. The fine fiber-forming material jet is drawn to the conductor (e.g., a grounded conductor), which is placed opposing the spinneret. While being drawn to the conductor, the jet cools and hardens into coating-receptive fibers. Preferably, the fibers are deposited on a collector that is placed in front of the conductor. In some embodiments, fibers are deposited on the collector as a randomly oriented, non-woven mat or individually captured and wound-up on a roll. The fibers are subsequently stripped from the collector if desired. In other embodiments, a charged conductor (opposite polarity to that of electrode) is employed instead of the grounded conductor.

The parameters for operating the electrospinning apparatus for effective melt spinning of fiber-forming materials can be readily determined by a person of ordinary skill in the art without undue experimentation. By way of a preferred example, the spinneret is generally heated up to about 300° C., the spin electrode temperature is maintained at about 10° C. or higher (e.g., up to just below a decomposition temperature of the fiber-forming material or up to about 150° C. higher) above the melting point or temperature at which the fiber-forming material has sufficiently low viscosity to allow thin coating-receptive fiber formation, and the surrounding environmental temperature is unregulated or, optionally, heated (e.g., maintained at about similar temperatures using hot air). Alternatively, the spinneret is generally heated up to about 300° C. and the surrounding environmental temperature optionally is maintained at about room temperature (i.e., from about 20° C. to 30° C.). The applied voltage is generally about 1 kV to 120 kV, preferably 1 kV to 80 kV. The electrode gap (the gap between spin electrode and collector) is generally between about 3 cm and about 50 cm, preferably about 3 cm and about 19 cm. Preferably, the coating-receptive fibers are fabricated at about ambient pressure (e.g., 1.0 atmosphere) although the pressure can be higher or lower. Preferred electrospinning devices are those that are marketed commercially as being useful for melt electrospinning. Use of commercially available melt electrospinning device such as NS Lab M device, Elmarco s.r.o., Liberec, Czech Republic (e.g., using Nanospider™ technology), are more preferred.

### Producing Coating-Receptive Fibers Comprising Fiber-Forming Materials by Melt Blowing

A melt blowing device typically comprises at least one die block having a portion that functions as a die tip; at least one gas knife assembly; a source of a stretch gas stream; and a collector, wherein the source of a stretch gas stream independently is in operative fluid communication with the gas knife assembly and the die tip. The die tip defines at least one, preferably a plurality of, apertures through which a melt of a fiber-forming material to be melt blown passes. A source of the melt is in operative fluid communication with the apertures of the die tip. An example of a melt blowing device is an Oerlikon Neumag Meltblown Technology™ system (Oerlikon Heberlein Wattwil AG, Switzerland). Preferably, the stretch gas is air sourced from a compressed air chamber and temperature of the stretch gas is measured in the compressed air chamber.

The invention herein may use any melt blowing system but preferably uses specialized process melt-blowing systems produced by Hills, Inc. of West Melbourne, Fla. 32904. See e.g. U.S. Pat. No. 6,833,104 B2, and WO 2007/121458 A2 the teachings of each of which are hereby incorporated by reference. See also www.hillsinc.net/technology.shtml and www.hillsinc.net/nanomeltblownfabric.shtml and the article “Potential of Polymeric Nanofibers for Nonwovens and Medical Applications” by Dr John Hagewood, J. Hagewood, L L C, and Ben Shuler, Hills, Inc, published in the 26 Feb. 2008 Volume of Fiberjournal.com. Preferred dies have very large Length/Diameter flow channel ratios (L/D) in the range of greater than 20/1 to 1000/1, preferably greater than 100/1 to 1000/1, including for example, but not limited to, L/D values 150/1, 200/1, 250/1, 300/1 and the like so long as there is sufficient polymer back pressure for even polymer flow distribution. Additionally, the die spinholes (“holes”) are typically on the order of 0.05 to 0.2 mm in diameter.

Preferably, average fiber diameter for a plurality of fibers is determined by processing a SEM image thereof with, for example, a QWin image analysis system (Leica Microsystems GmbH, 35578 Wezlar, Germany).

The coating-receptive fiber(s) useful in the present invention are used in a process of the first embodiment of the present invention in woven or non-woven form and in the form of a fabric, including a woven fabric, or article. In said process, the term “medium” means a solution of a self-assembling peptide or a self-assembled peptide polymer, or a combination thereof, essentially completely dissolved in a peptide-coating solvent or a suspension comprising said solution and an undissolved amount of said self-assembling peptide, self-assembled peptide polymer, or combination thereof suspended therein. Preferably, said undissolved amount is 10 wt % or less, more preferably 5 wt % or less, still more preferably 2 wt % or less, even more preferably less than 1 wt % of the total amount of said self-assembling peptide, self-assembled peptide polymer, or combination thereof.

In another preferred embodiment, the coating-receptive fiber(s) useful in the present invention are employed in a process of the first embodiment, the process employing a device for fabricating fibers that preferably includes a collector as described above, the process further comprising steps for fabricating the coating-receptive fiber(s), wherein the medium comprising at least one self-assembled peptide polymer and a peptide-coating solvent is contacted to the coating-receptive fiber before the coating-receptive fiber contacts the collector. More preferably, the process of fabricating a peptide-coated fiber comprises: (i) providing a melt of a fiber-forming material or providing a solution of a fiber-forming material and a solution-electrospinning solvent;
(ii) either feeding the solution into an electrospinning device comprising at least one electrode, at least one conductor, a source of voltage, and a collector, wherein the electrode(s) independently is in operative electricity communication with the source of voltage and with the conductor, feeding the melt into the electrospinning device, or feeding the melt into a melt blowing device comprising at least one die block having a portion that functions as a die tip, at least one gas knife assembly, a source of a stretch gas stream, and a collector, wherein the source of a stretch gas stream independently is in operative fluid communication with the gas knife assembly and the die tip; (iii) either applying a voltage to the electrospinning device such that the solution of the fiber-forming material and the solution-electrospinning solvent is drawn and a jet is formed from which the solution-electrospinning solvent dissipates to provide a coating-receptive fiber of the fiber-forming material, applying a voltage to the electrospinning device such that the melt of the fiber-forming material is drawn and a jet is formed to provide a coating-receptive fiber of the fiber-forming material, or streaming a stretch gas against the die tip and through the gas knife assembly of the melt blowing device such that the melt of the fiber-forming material is blown and a jet is formed from the die tip to provide a coating-receptive fiber of the fiber-forming material, the coating-receptive fiber having a diameter of 10 μm or less; (iv) contacting the coating-receptive fiber to a medium comprising at least one self-assembled peptide polymer and a peptide-coating solvent before the coating-receptive fiber contacts the collector, wherein said at least one self-assembled peptide polymer is dissolved in the peptide-coating solvent, wherein each self-assembled peptide polymer independently comprises two or more self-assembling peptides and each self-assembling peptide is the same or different and independently comprises a self-assembly segment of from 2 to 59 amino acid residues and, optionally, one or two supplemental segments each independently comprising 1 or more amino acid residues; and (v) allowing the at least one self-assembled peptide polymer to at least partially coat the coating-receptive fiber; wherein the solution-electrospinning solvent and the peptide-coating solvent are the same or different and the process produces at least one peptide-coated fiber of the second embodiment.

A “peptide-coating solvent” means any liquid suitable for at least partially dissolving a plurality of self-assembling peptides. Preferably, each self-assembling peptide is fully dissolved in the solvent. Ideally, the peptide-coating solvent is chemically compatible with a coating-receptive fiber (i.e., at most the solvent dissolves or otherwise removes less than 5 wt %, preferably less than 1 wt %, more preferably less than 0.2 wt % of the fiber during a fiber-coating process of the third embodiment). Examples of preferred peptide-coating solvents are polar aprotic solvents (e.g., dimethylsulfoxide (DMSO), N,N-dimethylformamide (DMF), N,N-dimethylacetamide (DMA), tetrahydrofuran (THF), and ethyl acetate), polar protic solvents such as water, ethanol, methanol, acetic acid, and formic acid), and combinations thereof. More preferably, the peptide-coating solvent comprises purified water (e.g., deionized or distilled water), acidic water (i.e., water having a pH less than 7, preferably by virtue of containing inorganic acid(s) such as hydrochloric acid), basic water (i.e., water having a pH greater than 7, preferably by virtue of containing inorganic base(s) such as sodium hydroxide), ionic water (e.g., water containing dissolved salt such as sodium chloride), 1,1,1,3,3,3-hexafluoropropan-2-ol, tetrafluoromethane, chloroform, methanol, N,N-dimethylacetamide, N,N-dimethylformamide, tetrahydrofuran, formamide, toluene, 1-propanol, 2-propanol, ethanol, and dichloromethane.

In a further step of a process of the first embodiment, a substantial portion of peptide-coating solvent is removed from a peptide-coated fiber in contact therewith by, for example, evaporation (under ambient or non-ambient (higher or lower) temperatures, pressures, or both), washing with a different solvent or other liquid (e.g., a liquid suitable for further processing of said peptide-coated fiber), blotting, spinning (e.g., centrifuging), blowing (including blowing with a heated gas), suction, freeze-drying, or a combination thereof. Removing a “substantial portion” of said peptide-coating solvent from said peptide-coated fiber gives a resulting dried peptide-coated fiber wherein said peptide-coating solvent accounts for less than 10 wt %, preferably less than 5 wt %, more preferably less than 2 wt %, even more preferably less than 1 wt % of a weight of said dried peptide-coated fiber.

### Self-Assembling Peptides

Each self-assembled peptide polymer independently comprises a plurality (i.e., 2 or more) of self-assembling peptides. The self-assembling peptides are the same or different and each self-assembling peptide independently comprises a self-assembling segment of from 2 to 59 amino acid residues and, optionally, one or two supplemental segments each independently comprising 1 or more amino acid residues. The self-assembly segment being covalently bonded to the supplemental segment(s), preferably each via a peptide bond (i.e., preferably an amide bond, that is a —C(O)—N< bond). Preferably, each supplemental segment comprises 2,000 amino acid residues or fewer, more preferably 1,000 amino acid residues or fewer, still more preferably 500 amino acid residues or fewer, even more preferably 250 amino acid residues or fewer.

The self-assembling peptides are the same or different and are capable of organizing with each other into said self-assembled peptide polymer, which is further described below. In some aspects of the first embodiment, the self-assembling peptides of the plurality thereof are the same. In other aspects of the first embodiment, at least two of the self-assembling peptides of the plurality thereof are different.

In some instances, self-assembling peptides useful in the present invention preferably comprise self-assembling segments comprising 40 or fewer amino acid residues, more preferably 38 or fewer such residues; or still more preferably 30 or fewer such residues; and the self-assembling peptides preferably comprise 4 or more such residues, more preferably 7 or more such residues, or still more preferably 10 or more such residues. In some instances, the self-assembling segments preferably comprise about 11, about 24, about 27, or about 37 such residues.

In some embodiments, amino acid residues useful in the present invention are derived from non-naturally occurring (i.e., not found in proteins in nature) amino acids such as, for example, levorotary-(L-) form of ornithine (Orn) and those non-naturally occurring amino acids recited in table 3 of USPAPN US 2006/0121083, which table 3 is incorporated herein by reference. Such non-naturally occurring amino acids include dextrorotary-(D-) forms and chemically modified forms of naturally occurring L-amino acids. Preferred chemically-modified forms of such an amino acid residue include acyl-modified amino group (e.g., acetylation of an —NH₂ of an N-terminal amino acid residue to form CH₃C(O)N(H)—) and an amine-modified carboxyl group (e.g., —C(O)NH₂).

Preferably, the amino acid residues are derived from the following naturally occurring (i.e., found in proteins in nature) L-amino acids (conventional three letter and single letter codes): L-alanine (Ala; A), L-arginine (Arg; R), L-asparagine (Asn; N), L-aspartic acid (Asp; D), L-cysteine (Cys; C), L-glutamine (Gln; Q), L-glutamic acid (Glu; E), glycine (Gly; G), L-histidine (His; H), L-isoleucine (Ile; I), L-leucine (Leu; L), L-lysine (Lys; K), L-methionine (Met; M), L-phenylalanine (Phe; F), L-proline (Pro; P), L-serine (Ser; S), L-threonine (Thr; T), L-tryptophan (Trp; W), L-tyrosine (Tyr; Y), and L-valine (Val; V). These L-amino acids are referred to by generic three letter and single letter codes Xxx and X, respectively. Unless otherwise stated, an amino acid, or residue thereof, described herein is in L-configuration.

Self-assembling peptides useful in the present invention are prepared by a number of conventional methods such as, for example, classical peptide synthesis comprising liquid-phase or solid-phase coupling of amino acids and classical protein expression methods. Systems useful for protein expression of the self-assembling peptides include bacterial, yeast, baculovirus/insect, and mammalian expression systems.

The self-assembling peptides prepared by peptide synthesis preferably lack supplemental segment(s). Supplemental segments typically derive from residuals of protein expression of the self-assembling peptides. Preferably, the supplemental segment(s) are cleaved from a self-assembling segment to give a self-assembling peptide consisting essentially of the self-assembling segment. For economic or other reasons, however, it may be desirable in some aspects of the first and embodiments to employ multi-segment self-assembling peptides comprising the self-assembling segments and the supplemental segments. Such multi-segment self-assembling peptides may be cheaper to prepare than self-assembling peptides consisting essentially of self-assembling segments.

Preferred self-assembling peptides useful in the present invention are described in the following patents and publications: (a) USPN: U.S. Pat. No. 6,858,581 B2, more preferably said peptide is of any one of SEQ ID NOS: 1 to 31 thereof; family members U.S. Pat. No. 7,321,022 B2 and U.S. Pat. No. 7,348,399 B2, more preferably said peptide is of any one of SEQ ID NOS: 1 to 8 thereof; (b) USPAPN: US 2006/0121083, more preferably said peptide is of any one of SEQ ID NOS: 1 to 6 thereof; US 2006/0166883, more preferably said peptide is of any one of SEQ ID NOS: 1 to 11 thereof; US 2008/0069849, more preferably said peptide is of any one of SEQ ID NO: 1 thereof and disclosed analogs thereof; US 2004/0135967, more preferably said peptide is of any one of: cecropin A-melittin hybrid, indolicidin, lactoferricin, Defensin 1, Bactenecin (bovine), Magainin 2, and mutacin 1140; and (c) PCT-IPAPN: WO 02/064183, more preferably said peptide is of any one of: protamine, melittin, protamine melittin, cecropin A, and nisin. Said publications are incorporated herein in their entireties by reference. Also preferred are self-assembling peptides of Chinese Patent number CN 1899601 A that have the sequence listings of SEQ ID NOS: 22 to 33 set forth further below in Table 6.

More preferred self-assembling peptides useful in the present invention are described in PCT-IPAPNs: WO 96/31528; WO 02/081104; and WO 2004/007532 and their respective U.S. family members USPAPN: US 2002/0132974; US 2004/0235048; and US 2006/0154852, each of which USPAPN hereby is incorporated herein in its entirety by reference. Other preferred self-assembling peptides useful in the present invention are described below.

US 2002/0132974 generally relates to peptides that self assemble to form β-sheet tape-like polymers comprised of monomers that are the self-assembling peptides. Preferably, the self-assembling peptides comprise from 4 to 40 amino acid residues, more preferably from 20 to 30 amino acid residues, still more preferably 27, 24, or 21 amino acid residues.

All sequence listings herein are shown left-to-right from N-terminus to C-terminus. Still more preferred is a self-assembling peptide of any one of sequence identifier numbers (SEQ ID NOS:) 1 to 8, which have the sequence listings set forth below in Table 1.

TABLE 1

| SEQ | |
|---|---|
| ID | |
| NO: | Sequence Listing |
| 1 | CH₃C(O)-Gln Ala Thr Asn Arg Asn Thr Asp Gly Ser |
| | Thr Asp Tyr Gly Ile Leu Gln Ile Asn Ser-NH₂ |
| 2 | Pro Ala Leu Leu Thr Asp Met Arg Asn Leu Ser His |
| | Leu Glu Leu Arg Ala Asn Ile Glu Glu Met |
| 3 | CH₃C(O)-Gln Ala Thr Asn Arg Asn Thr Asp Gly Ser |
| | Thr Asp Tyr Gly Ile Leu Gln Ile Asn Ser Arg-NH₂ |
| 4 | Lys Leu Glu Ala Leu Trp Leu Gly Phe Phe Gly Phe |
| | Phe Ile Leu Gly Ile Ser Tyr Ile Arg |
| 5 | Lys Leu Glu Ala Leu Tyr Val Leu Gly Phe Phe Gly |
| | Phe Phe Thr Leu Gly Ile Met Leu Ser Tyr Ile Arg |
| 6 | Lys Leu Glu Ala Leu Tyr Ile Leu Met Val Leu Gly |
| | Phe Phe Gly Phe Phe Thr Leu Gly Ile Met Leu Ser |
| | Tyr Ile Arg |
| 7 | CH₃C(O)-Lys Leu Glu Ala Leu Tyr Ile Leu Met Val |
| | Leu Gly Phe Phe Gly Phe Phe Thr Leu Gly Ile Met |
| | Leu Ser Tyr Ile Arg-NH₂ |
| 8 | Lys Leu Glu Ala Leu Tyr Ile Leu Met Val Leu Gly |
| | Phe Phe Gly Phe Phe Thr Cys Gly Ile Met Leu Ser |
| | Tyr Ile Arg |

Without being bound by theory, each of the self-assembling peptides of SEQ ID NOS: 1 to 9 self assemble to form P-sheet, tape-like self-assembled peptide polymers comprising complimentarily-bonded, anti-parallel arranged, homopeptide polymers.

US 2004/0235048 generally relates to coated substrates comprising a substrate and peptides that self assemble to form β-sheet tape-like polymers, wherein each substrate has a surface in operative coating contact with one or more layers of the β-sheet tape-like polymers. Each β-sheet tape-like polymer preferably is substantially parallel to the surface of the substrate and is essentially one molecule in thickness. When such self-assembling peptides are comprised of naturally occurring L-amino acids, the thickness of each layer is typically from about 0.5 nanometers (nm) to about 2 nm. When such self-assembling peptides are comprised of one or more non-naturally occurring amino acids, the thickness of each layer is up to about 5 nm, depending on length of side chains of the non-naturally occurring amino acids.

US 2006/0154852 generally relates to peptides that self assemble to form, depending on conditions employed, β-sheet tape-like polymers (tapes), ribbons comprised of two stacked tapes, fibrils comprised of a plurality of ribbons stacked together, or peptide fibers comprised of entwined fibrils. Preferably, the self-assembling peptides comprise from 7 to 30 amino acid residues, more preferably 8 to 12 such residues, still more preferably 10 or 11 such residues, even more preferably 11 such residues.

Also still more preferred is a self-assembling peptide of any one of SEQ ID NOS: 9 to 15, which have the sequence listings set forth below in Table 2.

TABLE 2

| SEQ | |
|---|---|
| ID | |
| NO: | Sequence Listing* |
| 9 | CH₃C(O)-Gln Gln Arg Gln Gln Gln Gln Gln Glu Gln |
| | Gln-NH₂ |
| 10 | CH₃C(O)-Gln Gln Arg Phe Gln Trp Gln Phe Glu Gln |
| | Gln-NH₂ |
| 11 | CH₃C(O)-Gln Gln Arg Phe Glu Trp Glu Phe Glu Gln |
| | Gln-NH₂ |
| 12 | CH₃C(O)-Gln Gln Orn Phe Orn Trp Orn Phe Gln Gln |
| | Gln-NH₂ |
| 13 | CH₃C(O)-Gln Gln Arg Phe Orn Trp Orn Phe Glu Gln |
| | Gln-NH₂ |
| 14 | CH₃C(O)-Gln Gln Glu Phe Glu Trp Glu Phe Glu Gln |
| | Gln-NH₂ |
| 15 | CH₃C(O)-Gln Gln Orn Phe Orn Trp Orn Phe Orn |
| | Gln-NH₂ |

*Orn means L-ornithine

Without being bound by theory, depending on conditions employed, the self-assembling peptides of SEQ ID NOS: 9 to 15 self assemble to form β-sheet tape-like self-assembled peptide polymers, ribbons comprised of two stacked said tape-like self-assembled peptide polymers, fibrils comprised of a plurality of said ribbons stacked together, or peptide fibers comprised of entwined said fibrils. The β-sheet tape-like self-assembled peptide polymers include complimentarily-bonded, anti-parallel arranged, homopeptide polymers comprised of any one of SEQ ID NOS: 9 to 15 and complimentarily-bonded, anti-parallel arranged, alternating peptide copolymers comprised of any two complimentary peptides of SEQ ID NOS: 9 to 15 (e.g., complimentary peptides of SEQ ID NOS: 11 and 12).

Other more preferred self-assembling peptides useful in the present invention are those that form β-sheet tape-like self-assembled peptide polymers in an aqueous medium and comprise 3 or more polar/neutral amino acid residues and a plurality of chargeable amino acid residues (total number of amino acid residues being within the limits described herein). Where the self-assembling peptides are comprised of 11 amino acid residues, preferably a ratio of chargeable amino acid residues to polar/neutral amino acid residues is from 1:11 to 4:11, preferably 3:11 or 4:11. More preferably, the self-assembling peptides are complimentarily-bonded, anti-parallel arranged, alternating peptide copolymers. In some embodiments, complimentarity of any two complimentary self-assembling peptides comprising said alternating peptide copolymers originates from opposite charges being present at a particular pH employed, e.g., at the pH employed, there is a net positive charge on one of self-assembling peptides and a net negative charge on the other one of self-assembling peptides.

Polar/neutral amino acid residues are the same or different and each residue independently and preferably is a residue of glutamine, serine, asparagine, ornithine, cysteine, lysine, histidine, glutamic acid, or threonine. Chargeable amino acid residues include those internal (in a self-assembling peptide) residues that are positively charged at a pH of less than or equal to 7 (i.e., neutral pH), e.g., charged somewhere in a range of pH 2 to pH 7, and those residues that are negatively charged at a pH of greater than or equal to 7, e.g., charged somewhere in a range of pH 7 to pH 13, and those residues that are both positively and negatively charged. Chargeable amino acid residues are the same or different and each residue independently and preferably is a residue of arginine, aspartic acid, cysteine, glutamic acid, histidine, lysine, ornithine, tryptophan, or tyrosine. Examples of apolar amino acid residues are phenylalanine, valine, leucine, isoleucine, and methionine. For purposes of the present invention, an internal tryptophan residue is apolar at or below neutral pH. For example, the self-assembling peptide of SEQ ID NO: 9 comprises a chargeable amino acid residue; the self-assembling peptides of SEQ ID NOS: 10, 11, 12, and 13 comprise from 1 to 3 chargeable amino acid residues; and the self-assembling peptides of SEQ ID NOS: 14 and 15 comprise 3 or more chargeable amino acid residues.

Also still more preferred is a self-assembling peptide of any one of SEQ ID NOS: 16 and 17, which have the sequence listings set forth below in Table 3.

TABLE 3

| SEQ | |
|---|---|
| ID | |
| NO: | Sequence Listing* |
| 16 | CH₃C(O)-Ser Ser Arg Phe Glu Trp Glu Phe Glu Ser |
| | Ser-NH₂ |
| 17 | CH₃C(O)-Ser Ser Arg Phe Orn Trp Orn Phe Glu Ser |
| | Ser-NH₂ |

*Orn means L-ornithine

Also still more preferred is a self-assembling peptide of any one of SEQ ID NOS: 18 to 24, which have the sequence listings set forth below in Table 4.

TABLE 4

| SEQ | |
|---|---|
| ID | |
| NO: | Sequence Listing |
| 18 | CH₃C(O)-Gln Gln Arg Phe Gln Trp Gln Phe Glu Gln |
| | Gly Pro Gly Gly Ser Gln Phe Gln Trp Gln Phe Gln |
| | Ser Gly Pro Gly Gly Gln Glu Phe Gln Trp Gln Phe |
| | Arg Gln Gln-NH₂ |
| 19 | CH₃C(O)-Gln Cys Arg Phe Gln Trp Gln Phe Glu Cys |
| | Gly Pro Gly Gly Ser Gln Phe Gln Trp Gln Phe Gln |
| | Ser Gly Pro Gly Gly Cys Glu Phe Gln Trp Gln Phe |
| | Arg Cys Gln-NH₂ |
| 20 | CH₃C(O)-Glu Gln Glu Phe Glu Trp Glu Phe Glu Gln |
| | Glu-NH₂ |
| 21 | CH₃C(O)-Gln Gln Orn Phe Orn Trp Orn Phe Orn Gln |
| | Gln-NH₂ |

Also still more preferred is a self-assembling peptide of any one of SEQ ID NOS: 22 to 27, which have the sequence listings set forth below in Table 5.

TABLE 5

| SEQ | |
|---|---|
| ID | |
| NO: | Sequence Listing |
| 22 | CH₃C(O)-Gln Arg Phe Gln Trp Gln Phe Glu Gln-NH₂ |
| 23 | CH₃C(O)-Arg Phe Gln Trp Gln Phe Glu-NH₂ |
| 24 | CH₃C(O)-Phe Gln Trp Gln Phe-NH₂ |
| 25 | CH₃C(O)-Phe Arg Trp Glu Phe-NH₂ |
| 26 | CH₃C(O)-Gln Trp Gln-NH₂ |
| 27 | CH₃C(O)-Arg Trp Glu-NH₂ |

More preferably, each self-assembling peptide useful in the present invention independently is of any of one of SEQ ID NOS: 1 to 27, still more preferably of any of one of SEQ ID NOS: 5, 10, and 11.

The aforementioned self-assembling peptides of Chinese Patent number CN 1899601 have the sequence listings of SEQ ID NOS: 28 to 39 set forth below in Table 6.

TABLE 6

| SEQ | |
|---|---|
| ID | |
| NO: | Sequence Listing |
| 28 | Lys Gly Ala Arg Lys Gly Ala Lys Arg Gln Gly Gly |
| | Lys Lys Val Ala Arg Lys Ala Leu Lys Arg Ala Gly |
| | Lys |
| 29 | Lys Gly Gly Arg Lys Gly Ala Lys Arg Gln Gly Gly |
| | Lys Lys Leu Ala Arg Lys Ala Leu Lys Arg Ala Gly |
| | Arg |
| 30 | Lys Gly Gly Arg Lys Gly Ala Lys Arg Gln Gly Gly |
| | Lys Lys Leu Ala Arg Lys Ala Leu Lys |
| 31 | Lys Gly Val Arg Lys Gly Ala Lys Arg Gln Gly Cys |
| | Lys Lys Leu Ala Arg Lys Ala Leu Lys |
| 32 | Lys Gly Ala Arg Arg Gly Ala Lys Arg Gly Gly Lys |
| | Lys Leu Ala Arg Lys Ala Leu Lys |
| 33 | Lys Gly Ala Arg Arg Leu Ala Lys Arg Ser Gly Lys |
| | Lys Val Ala Arg Lys Ala Gly Arg |
| 34 | Lys Phe Ala Arg Arg Leu Ala Lys Arg Leu Gly Lys |
| | Lys Val Ala Arg Lys Leu Gly Arg |
| 35 | Lys Phe Leu Arg Arg Leu Ile Lys Arg Leu Val Lys |
| | Lys Val Leu Arg Lys Leu Gly Arg |
| 36 | Lys Ala Ala Lys Lys Ala Ala Lys Arg Ala Ala Lys |
| | Lys Ala Thr Arg |
| 37 | Lys Ala Leu Lys Lys Ala Leu Lys Arg Ala Leu Lys |
| | Lys Ala Leu Arg |
| 38 | Lys Gly Leu Lys Lys Gly Leu Lys Arg Gly Leu Lys |
| | Lys Gly Leu Arg |
| 39 | Lys Ala Thr Lys Lys Ala Leu Lys Arg Ala Gly Lys |
| | Lys Ala Thr Arg |

Self-assembling peptides of SEQ ID NOS: 1 to 39 lack supplemental segments, i.e., consist essentially of self-assembling segments.

### Self-Assembled Peptide Polymers

A peptide coating comprises one or more self-assembled peptide polymers. A “self-assembled peptide polymer” means at least two self-assembling peptides are complementarily-bonded, preferably reversibly, to each other. A self-assembled peptide polymer is characterized as having a first portion that comprises part or all of the self-assembling segments of the self-assembling peptides comprising the self-assembled peptide polymer. The self-assembling segments are complementarily-bonded, preferably reversibly, to each other. Where the self-assembling peptide also comprises one or more supplemental segments, the self-assembled peptide polymer is further characterized as having a second portion that comprises the supplemental segments, which optionally are or are not complementarily-bonded, preferably reversibly, to each other.

A preferred self-assembled peptide polymer comprises a P-sheet tape. When a self-assembled peptide polymer comprises one or more β-sheet tapes, preferably at least one, more preferably each, β-sheet tape comprises an anti-parallel arrangement of two or more self-assembling peptides in the self-assembled peptide polymer. Also preferred is a self-assembled peptide polymer comprising two or more β-sheet tapes, a ribbon comprising two or more stacked β-sheet tapes, a fibril comprising two or more said ribbons stacked together, or a peptide fiber comprising an entwined plurality of said fibrils. Examples of said ribbon, fibril, and peptide fiber are described in USPAPN 2006/0154852, supra.

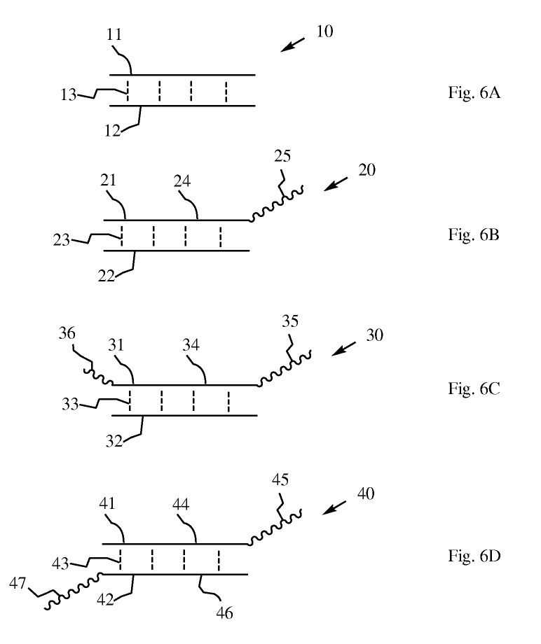

Non-limiting generic representations of self-assembled peptide polymers useful in the present invention are illustrated below in FIGS. 6A to 6D. FIG. 6A depicts a self-assembled peptide polymer 10 comprised of two self-assembling peptides 11 and 12 and four non-covalent functional group interactions 13, wherein self-assembling peptides 11 and 12 each consist essentially of a self-assembling segment (not separately indicated). FIG. 6B depicts a self-assembled peptide polymer 20 comprised of two self-assembling peptides 21 and 22 and four functional group interactions 23, wherein self-assembling peptide 21 comprises a self-assembling segment 24 and a supplemental segment 25 and self-assembling segment 22 consists essentially of a self-assembling segment (not separately indicated). FIG. 6C depicts a self-assembled peptide polymer 30 comprised of two self-assembling peptides 31 and 32 and four functional group interactions 33, wherein self-assembling peptide 31 comprises a self-assembling segment 34, a supplemental segment 35, and a supplemental segment 36 and self-assembling segment 32 consists essentially of a self-assembling segment (not separately indicated). FIG. 6D depicts a self-assembled peptide polymer 40 comprised of two self-assembling peptides 41 and 42 and four functional group interactions 43, wherein self-assembling peptide 41 comprises a self-assembling segment 44 and a supplemental segment 45 and self-assembling segment 42 comprises a self-assembling segment 46 and a supplemental segment 47 (depicted here in a quasi head-to-tail arrangement, although a quasi head-to-head arrangement is also contemplated).

### Peptide-Coated Fibers

A self-assembled peptide polymer comprising peptide-coated fiber is characterized as having a third portion that is in operative coating contact with a coating-receptive fiber. The third portion typically comprises part or all of the self-assembling segments of the self-assembling peptides comprising the self-assembled peptide polymer. Where the self-assembling peptides also comprise supplemental segments, the self-assembled peptide polymer is further characterized as having a fourth portion that optionally is or is not in operative coating contact with the coating-receptive fiber.

The term “operative” means effective, i.e., via direct or indirect means. The phrase “operative coating contact” means a peptide coating comprising one or more self-assembled peptide polymers is in direct physical contact (i.e., in single layer coatings and the first layer of a multi-layer coating) or indirect physical contact (i.e., sequentially second and higher layers of multi-layer coatings) with a coating-receptive fiber and said one or more self-assembled peptide polymers are physically at least partially wrapped around (as described below) the coating-receptive fiber, interact with functional groups of the coating-receptive fiber as described below, or, preferably, a combination thereof. A partially wrapped coating means at least one complete turn of a self-assembled peptide polymer around the coating-receptive fiber as determined by processing a SEM image thereof with, for example, a QWin image analysis system, supra). In some embodiments, the coating-receptive fiber is coated along substantially (i.e., greater than 80% of) its length. In other embodiments, the coating-receptive fiber is coated along less than 80% of its length.

Said operative coating contact preferably comprises a plurality of functional group interactions between functional groups comprising the coating-receptive fiber and functional groups comprising the self-assembled peptide polymers. Such functional group interactions preferably comprise non-covalent interactions, one or more covalent bonds, preferably and 2 or fewer covalent bonds, more preferably 1 or 0 covalent bonds, more preferably 0 covalent bonds, or a combination thereof per self-assembled peptide polymer. Examples, without limitation or being bound by theory, of said non-covalent interactions are electrostatic interactions (ion-ion, ion-dipole or dipole-dipole) or coordinative bonding (metal-ligand); hydrogen bonding; π-π stacking interactions; van der Waals forces; and combinations thereof. Preferred examples without limitation or being bound by theory, of said covalent bond is a disulfide bond, i.e., the bond of the -sulfur-sulfur-diradical (—S—S—), carbon-oxygen carboxylic ester bond

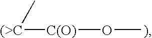

carbon-oxygen carbonate bond (—O—C(O)—O—), carbon-nitrogen carboxamide bond

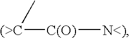

carbon-nitrogen urea bond (>N—C(O)—N<), and carbon-nitrogen or carbon-oxygen carbamate bond (—O—C(O)—N<)<), wherein “>” and “<” indicate two radical bonds. Still more preferably, said operative coating contact comprises a combination of said at least partially wrapped coating and said plurality of functional group interactions.

Reversibility of the “reversible operative coating contact” refers to an ability of a coating-receptive fiber and one or more self-assembled peptide polymers, or an outer layer of a peptide-coated fiber and one or more other self-assembled peptide polymers to form, break, or a combination thereof said operative coating contact. Where said operative coating contact comprises at least one covalent bond, said reversibility optionally comprises or does not comprise forming, breaking, or a combination thereof, one or more of said covalent bonds. Preferably, at least one covalent bond is not broken.

Preferably, processes of forming (i.e., coating) and breaking (i.e., releasing a coating) said non-covalent interactions are responsive to coating triggers. A “coating trigger” means a chemical or physical means of inducing assembly of two or more self-assembling peptides into a self-assembled peptide polymer, inducing coating of a coating-receptive fiber by a self-assembled peptide polymer, inducing further coating of a peptide-coated fiber by a same or different self-assembled peptide polymer, or a combination thereof. A total of 0, 1, 2 or more coating triggers are employed. Preferably 0, 1, or 2 coating triggers are employed. For example in some embodiments, a first coating trigger induces assembly of two or more self-assembling peptides into a self-assembled peptide polymer, a second coating trigger induces coating of a coating-receptive fiber by the self-assembled peptide polymer, or both. Alternatively in other embodiments, coating triggers induce release of a peptide coating from a peptide-coated fiber. Coating triggers independently are the same or different; when the same, coating triggers preferably are complimentary acting as described later. Preferably, coating triggers are used whenever convenient. For example in some embodiments, it is convenient to induce assembly of two or more self-assembling peptides dissolved in a medium into a self-assembled peptide polymer while a coating-receptive fiber to be coated therewith, or a peptide-coated fiber to be further coated therewith, is in contact with the medium.

Coating triggers useful in the present invention are described in the following publications: US 2002/0132974; US 2004/0235048; US 2006/0154852; Aggeli A., et al., Hierarchical self-assembly of chiral rod-like molecules as a model for peptide β-sheet tapes, ribbons, fibrils, and fibers, Proceedings of the National Academy of Sciences (PNAS), Oct. 9, 2001; 98:11857-11862; Aggeli A., et al., pH as a Trigger of Peptide β-Sheet Self-Assembly and Reversible Switching between Nematic and Isotropic Phases, Journal of the American Chemical Society (J. Am. Chem. Soc.), 2003; 125:9619-9628; and Carrick L. M., et al., Effect of ionic strength on the self-assembly, morphology and gelation of pH responsive β-sheet tape-forming peptides, Tetrahedron, 2007; 63:7457-7467; each of which hereby is incorporated herein in its entirety by reference.

Preferably, a coating trigger comprises: varying the amino acid residue composition of the self-assembling peptide (i.e., using a different self-assembling peptide); chemically modifying a functional group of an amino acid residue comprising the self-assembling peptide; varying concentration (e.g., by evaporation of peptide-coating solvent) of the self-assembling peptide dissolved in a medium (e.g., water, an aqueous NaCl solution, an organic solvent such as chloroform or methanol, or a combination of water and a water miscible organic solvent); varying pH of a medium; varying ionic strength of a medium by adding ions (e.g., by using a 130 mM or 145 mM solution of NaCl in water instead of water as the medium), wherein the ions are anions or cations and are chosen from a Hofmeister series; adding one or more peptide-coating solvents (e.g., co-solvents) to a medium (e.g., adding water to a dimethylsulfoxide mixture); varying temperature of a medium; varying polarity of a medium (e.g., replacing a chloroform-based medium with an water-based medium); or a combination thereof. An additional coating trigger comprises radiation (e.g., light). Another coating trigger comprises effectively mixing the one complementary self-assembling peptide with the other, as described by Aggeli A., et al., Self-Assembling Peptide Polyelectrolyte β-Sheet Complexes Form Nematic Hydrogels, Angewandte Chemie Int. Ed., 2003; 43: 5603-5606,.

Preferably, a coating trigger, more preferably each coating trigger where there are two or more coating triggers, still more preferably each coating trigger for triggering release of a self-assembled peptide polymer from a peptide-coated fiber is environmentally activated (as opposed to being activated by a consciously-performed man-made activity). Such coating triggers respond to one or more natural changes in an environment that is in operative contact with a free self-assembling peptide or, preferably, a peptide coating comprised of a self-assembled peptide polymer.

When two coating triggers are the same, preferably they are complimentarily acting (i.e., have essentially opposite coating effects on self-assembled peptide polymers). Examples of complimentarily acting pH coating triggers are lowering pH of a medium (e.g., from pH 8.0 to pH 6.0) to trigger release of a self-assembled peptide polymer coating from a peptide-coated fiber that is in contact with the medium and raising said pH (e.g., from pH 6.0 to pH 8.0) to stop release of the self-assembling peptide polymer coating or trigger coating of a fiber (e.g., a coating-receptive fiber or peptide-coated fiber) in contact with the medium with a self-assembled peptide polymer, or vice versa.

More preferably, when two coating triggers are the same, they are complimentarily acting and environmentally activated. An example of complimentarily acting and environmentally activated coating triggers is a peptide-coated fiber of the present invention comprising an antimicrobial self-assembling peptide, wherein the peptide-coated fiber is in therapeutic contact with a wound infected with a bacteria in a patient having the wound. Such a bacteria may naturally create in the wound a micro-environment comprising a fluid (e.g., biological fluid) having pH less than 7.0, and thereby trigger release (e.g., dissolution) of self-assembled peptide polymer from the peptide-coated fiber (e.g., peptide coating releases from a coating-receptive fiber or a top layer or more of a multilayer peptide coating releases therefrom) and disassembly of the self-assembled peptide polymer into the antimicrobial self-assembling peptide. When the antimicrobial self-assembling peptide kills the bacteria and remains unchanged thereby, the pH of the micro-environment comprising the fluid will naturally return to the patient's physiological pH 7.4, and so trigger a complimentary re-coating of the fiber. Such re-coating comprises assembly of the released antimicrobial self-assembling peptide into a self-assembled peptide polymer, which then coats the fiber. Alternatively, the second coating trigger stops further dissolution of outer layers of the coating, causes recoating, or both

Peptide-coated fibers of the present invention may be prepared by any one of a number of processes. For example, the peptide-coated fibers are prepared by first fabricating a coating-receptive fiber useful in the present invention, and then contacting a self-assembled peptide polymer to the coating-receptive fiber, wherein the coating-receptive fiber optionally is or is not further processed (e.g., cleaned and collected) before it is contacted to the self-assembled peptide polymer. Alternatively, the coating-receptive fiber is fabricated and essentially simultaneously contacted to the self-assembled peptide polymer.

### Articles

Preferred is an article wherein the coating-receptive fiber of the peptide-coated fiber comprises a non-MSA material. Articles of the third embodiment of the present invention are manufactured from said peptide-coated fiber. In some embodiments, the articles further comprise the aforementioned collector employed for fabricating the coating-receptive fiber. Alternatively, said articles are manufactured from a coating-receptive fiber to give intermediate non-(peptide-coated) articles, and said non-(peptide-coated) articles are coated with a self-assembled peptide polymer according to a process of the first embodiment of the present invention. Said invention process is beneficially effective for coating exterior fibers (i.e., fibers that are proximal to surfaces of said non-(peptide-coated) articles) fibers and, optionally, interior fibers (i.e., fibers that are distal from surfaces of said non-(peptide-coated) articles), wherein “surfaces” means exterior and interior surfaces. For coating said interior fibers, said invention process maintains a contacting step for a time sufficient to allow a medium to penetrate (e.g., by injection or percolation) from a surface and contact said interior fibers. In some embodiments, any particular fiber has a portion that is at the exterior of, and a portion that is interior in, a non-(peptide-coated) article.

Preferably, an article of the third embodiment of the present invention is useful in a medical, personal hygiene, cleaning, or filtration application. Examples of invention articles for preferred medical applications are a bandage (e.g., for treating wounds), preferably an anti-infective bandage; a therapeutic patch (i.e., a patch useful for transdermally delivering a therapeutic agent to a patient); a medical garment (e.g., surgical gown and mask); and a medical fabric (e.g., a sheet for covering a bed in a patient or operating room, a curtain for screening off a patient treatment area, a wall covering for walls in a patient or operating room, a surgical drape, and a surgical towel). Examples of invention articles for preferred personal hygiene applications are diaper stock; feminine hygiene stock; a stocking (e.g., a sock); linings (e.g., for shoes and gloves); and underwear stock. Examples of invention articles for preferred cleaning applications are wipes (e.g., baby wipes); cleaning cloths; and food preparation surface barriers. More preferred are invention articles for anti-infective cleaning applications. Examples of invention articles for preferred filtration applications are filter stock, including filter stock for air filtration and liquid filtration applications.

In some embodiments, an article of the third embodiment of the present invention is maintained (e.g., stored) in a dry condition until ready for use. For example, an anti-infective cleaning cloth is kept in a dry condition until it is needed for use in an anti-infective cleaning application, whereupon it is activated by contact with a liquid such as water, sterile saline, or a biological fluid (e.g., blood from raw meat). Conventional anti-infective cleaning cloths typically are stored in a moist environment, which promotes loss of anti-infective potency of such cloths. Anti-infective cleaning cloths and other invention articles (e.g., bandages and stock for personal hygiene applications) useful in anti-infective applications are expected to possess longer shelf-lives compared to conventional moistened articles.

The term “anti-infective” means antiviral, antifungal, antiparasitic, antialgae, and, preferably, antimicrobial (i.e., antibacterial). Assays for testing anti-infective properties of peptides are known. Examples of such assays are found, for example, in U.S. Pat. No. 6,858,561, which hereby is incorporated by reference herein in its entirety.

Various methods including, for example, carbon-13 nuclear magnetic resonance (¹³C-NMR) and, preferably, proton nuclear magnetic resonance (¹H-NMR) may be used to determine monomer purity, copolymer composition, and copolymer number average molecular weight utilizing the CH₂OH end groups. Regarding ¹H-NMR, peak assignments are dependent on the specific structure being analyzed as well as the NMR solvent, concentration, and temperatures utilized for measurement. For ester amide monomers and co-polyesteramides, d₄-acetic acid is a convenient NMR solvent. For ester amide monomers of the type called DD that are methyl esters typical peak assignments are about 3.6 to 3.7 parts per million (ppm) for C(═O)—OCH₃; about 3.2 to 3.3 ppm for N—CH₂—; about 2.2 to 2.4 ppm for C(═O)—CH₂—; and about 1.2 to 1.7 ppm for C—CH₂—C. For co-polyesteramides that are based on DD with 1,4-butanediol, typical peak assignments are about 4.1 to 4.2 ppm for C(═O)—OCH₂—; about 3.2 to 3.4 ppm for N—CH₂—; about 2.2 to 2.5 ppm for C(═O)—CH₂—; about 1.2 to 1.8 ppm for C—CH₂—C, and about 3.6 to 3.75 —CH₂OH end groups.

The following preparations are not intended to limit scope of the present invention.

### Preparations—Fiber-Forming Materials

### Fiber-Forming Material Preparation 1: Preparation of MSA Material Poly(ester-amide) (PEA) P2-8 C2C-50%

A preferred amide diol is the condensation product prepared from ethylene diamine and ε-caprolactone, coded C2C in the preparations below, and which has the following structure: HO—(CH₂)₅—CONH—(CH₂)₂—NHCO—(CH₂)₅—OH.

Step (a) Preparation of the Diamide Diol Ethylene-N,N′-dihydroxyhexanamide (C2C).

C2C monomer is prepared by reacting 1.2 kilograms (kg) of ethylene diamine (EDA) with 4.56 kg of ε-caprolactone under a nitrogen blanket in a stainless steel reactor equipped with an agitator and a cooling water jacket. An exothermic condensation reaction between the ε-caprolactone and the EDA occurs which causes the temperature to rise gradually to 80° C. A white deposit forms and the reactor contents solidify, at which the stirring is stopped. The reactor contents are then heated to 160° C. at which temperature the solidified reactor contents melt. The liquid product is then discharged from the reactor into a collecting tray. A nuclear magnetic resonance study of the resulting product shows that the mole concentration of C2C in the product exceeds 80 percent. The melting point of the C2C diamide diol product is 140° C.

Step (b1) Contacting C2C with Dimethyl Adipate.

A devolitizer reactor is charged with 2.622 kg liquid dimethyl adipate and 2.163 kg of the solid C2C diamide diol produced as described above. The reactor contents are brought slowly under nitrogen purge to a temperature of 140° C. in order to melt the C2C in the reaction mixture. Step (b2) Contacting the composition with 1,4-butanediol without further addition of non-volatile diols, acids or branching agents.

1.352 kg of 1,4-butandiol are added to the reactor contents of step (b) followed by 105 milliliters (mL) of a 10 percent by weight solution of tetrabutoxy titanium (IV) in 1,4-butanediol. The resulting reaction results in the formation of methanol which is then removed as vapor by the nitrogen purge from the reactor system. The pressure in the system is maintained at atmospheric pressure, and temperature is gradually raised to 180° C. The reaction and distillation of methanol is continued until the evolution of methanol subsides. The pressure in the reactor is then lowered to an absolute pressure of 450 millibars (mbar) and then stepwise to 20 mbar, resulting in further evolution of methanol vapor from the reaction mixture. When the flow of methanol subsides the pressure in the reactor is further lowered an absolute pressure of 0.25 mbar to initiate distillation of 1,4-butandiol, and the temperature in the reactor is gradually increased to 200° C. When 710 mL of 1,4-butanediol has been recovered from the reactor, the vacuum in the reactor is broken and the resulting molten amide ester polymer composition is discharged from the reactor. The resulting polymer, designated_PEA P2-8 C2C-50% (i.e., 50 mole % C2C), has a Mₙ (by ¹H-NMR in d₄-acetic acid) of 7480 g/mol, i.e., about 7500 g/mol. Inherent viscosity=0.32 dL/g (methanol:chloroform (1:1 w:w), 30.0° C., 0.5 g/dL). By ¹H-NMR it was determined that 51.2 mole % of polymer repeat units contain C2C.

### Preparations—Coating-Receptive Fibers

### Coating-Receptive Fiber Preparation 1. Solution-Based Electrospinning of PEA P2-8 C2C-50

This example demonstrates the ability to electrospin submicron fibers from a solution of PEA P2-8 C2C-50 of Fiber-Forming Material Preparation 1, with number average molecular weight of about 7500 g/mol, in chloroform. The voltage is 18 kV and is applied 50% positive at the needle and 50% negative at the conductor. The syringe is a 10 mL syringe with an inner diameter of 15 mm. This diameter is used to calibrate the syringe pump. The needle is 20 gauge×2″ needle (0.584 mm inner diameter×5.1 cm length). Distance from the syringe nozzle to the collector is 20 centimeters (cm). The syringe pump flow rate of the solution is 20 mL/hour. Collection times ranged from 45 seconds to 5 minutes. Mean fiber diameter, median fiber diameter, mode fiber diameter and standard deviation of fiber diameter are given in micrometers (μm) below in Table 7.

TABLE 7

| | | | | | | | | | Standard |
|---|---|---|---|---|---|---|---|---|---|
| | | | distance | | | Mean | Median | Mode | Deviation |
| | | | to | | Flow | fiber | fiber | fiber | of fiber |
| Sample | | Voltage | collector | Needle | Rate | diameter | diameter | diameter | diameter |
| No. | Wt % | (kV) | (cm) | gauge | (mL/hr) | (μm) | (μm) | (μm) | (μm) |
| 1 | 12 | 18 | 20 | 20 | 20 | ND* | ND | ND | ND |

*ND means not determined.

### Preparations—Self-Assembling Peptides

US 2006/0154852 and Aggeli A., et al., J. Am. Chem. Soc., supra. Teach preparations of self-assembling peptides of SEQ ID NOS: 10 to 13. Self-assembling peptides of SEQ ID NOS: 9, 14, and 15 are prepared by adapting the preparations of SEQ ID NOS. 10-13. US 2002/0132974 teaches preparations of self-assembling peptides of SEQ ID NOS: 3, 5, and 6. Self-assembling peptides of SEQ ID NOS: 1, 2, 4, 7, 8 20, and 21 are prepared by adapting the preparations of SEQ ID NOS: 3, 5, and 6.

### Preparation of Self-Assembling Peptides of SEQ ID NOS: 22 to 27

### Step (a): Preparation of Unacetylated Forms of the Self-Assembling Peptide of Any One of SEQ ID NOS: 22 to 27

NOVASYN™ (Novabiochem AG, Switzerland) tetra gel rink amide (Novasyn TGR) resin is soaked in N,N-dimethylformamide (DMF) for approximately three hours. The resin mixture is transferred to a reaction vessel comprising a column having a sintered frit base, which allows an agitating gas to bubble up from below and liquids from above to be drained away. The resin is activated with 20% piperidine/DMF volume/volume (v/v) for 1 minute while bubbling with nitrogen (5 milliliters (mL) per 0.5 g resin). Then it is washed five times with DMF.

A solution of four mole equivalents of N-(9-fluorenylmethylformoyl)-amino acid (Fmoc-AA-OH) and four mole equivalents of O-(7-azabenzotriazol-1-yl)-1,1,3,3-tetramethyluronium hexafluorophosphate (HATU) is dissolved in 1.6 mL of 10% diisopropylethylamine in DMF (v/v), then diluted to 20 mL with additional DMF. This solution is added to the resin and the resulting mixture is left to couple for 2.5 hours, and then washed four times with DMF. The resulting protected peptide is then deprotected and washed in the manner shown below in Table 8 to give a resin-bound peptide attached to the resin via a linker.

TABLE 8

| | | Volume | Time |
|---|---|---|---|
| Solvent | Role of wash | (mL) | (minutes) |
| 20% (v/v) | Deprotection | 5 | 5 |
| piperidine/DMF | | | |
| DMF | Wash | 5 | 1 |
| | | | washing for 2 |
| | | | minutes |
| 20% (v/v) | Deprotection | 5 | 10 |
| piperidine/DMF | | | |
| DMF | Wash | 5 | 4 |
| | | | washings for 2 |
| | | | minutes each |

The above steps are repeated until all of the necessary amino acid residues are added and deprotected to separately give each of the unacetylated forms of the self-assembling peptide of any one of SEQ ID NOS: 22 to 27 bound to the resin via the linker.

### Step (b): Preparation of the Self-Assembling Peptide of Any One of SEQ ID NOS: 22 to 27

Each of the unacetylated peptides of step (a) are acetylated at the N-terminal and then cleaved from the resin. To separate DMF solutions of each of the resin-bound unacetylated peptides of step (a) are added 3×8.5 mL of a solution of 0.7 mL acetic anhydride and 25 mL of DMF and a solution of 0.06 mL of pyridine and 25 mL DMF. The resulting reaction solution is allowed to drain off through the sintered frit under gravity for approximately 30 minutes, leaving resin-bound acetylated peptide behind. The resin is washed twice with DMF, and dried under a vacuum. The resulting dried resin is washed with DMF, then 2 times with dichloromethane. When the resin floats in the dichloromethane, it is washed with methanol until it sinks, and the resulting resin is transferred to a beaker where it is covered and dried under vacuum overnight.

A cleavage mixture comprising phenol (0.1 g), anisole (0.2 mL), ethanedithiol (0.4 mL), water (0.2 mL), and trifluoroacetic acid (TFA) (9.2 mL) is added to the dried resin, and the mixture is agitated for 3 hours. The resulting solution above the resin is filtered off into a round bottom flask, and the resin is washed 2 times with 5 mL of TFA, and then dried under vacuum. The solution filtrate, which contains self-assembling peptide of any one of SEQ ID NOS: 22 to 27 that has been cleaved from the resin, is concentrated to 1 mL to 2 mL of an oil on a rotary evaporator.

A portion of the oil (1 mL) is added dropwise to cold diethyl ether (approximately 30 mL), and after precipitation occurs the resulting suspension is centrifuged for 10 minutes. The excess diethyl ether is decanted. Fresh cold diethyl ether (30 mL) is added and an additional 1 mL portion of the oil is added dropwise, and this step is repeated until all of the oil is treated. The resulting peptide residue is left to dry over night, then dissolved in distilled water and freeze dried to give the self-assembling peptide of any one of SEQ ID NOS: 22 to 27.

The following examples are illustrative of preferred embodiments of the present invention but are not intended to limit its scope.

### Examples

### Example 1

### Peptide-Coated Fiber Comprising a Coating-Receptive Fiber of Coating-Receptive Fiber Preparation 1 Comprised of a Poly(ester-amide) PEA P2-8 C2C-50% of Fiber-Forming Material Preparation 1 and a Self-Assembling Peptide of SEQ ID NO: 11

A control sample of non-woven fabric comprised of one or more coating-receptive fibers of Coating-Receptive Fiber Preparation 1 is set aside. Three test samples of non-woven fabric comprised of one or more coating-receptive fibers of Coating-Receptive Fiber Preparation 1 are placed in three separate 10 milligram per milliliter (mg/mL) monomeric peptide solutions of the self-assembling peptide of SEQ ID NO: 11 in water (with no added salt) at pH 8 and room temperature, and the peptide solution is allowed 1 hour to absorb within the PEA non-woven fabric. Then microliters of concentrated HCl solution (more than 0.1M HCl in water) are added to lower the pH of the solutions to pH 6, pH 4, and pH 2, respectively, in order to trigger self assembly of the monomeric peptides into self-assembled peptide polymers comprised of β-sheets and coating of the coating-receptive fiber(s) with the self-assembled peptide polymers. The test samples are left overnight in the resulting solutions/gels, and then removed and allowed to dry.

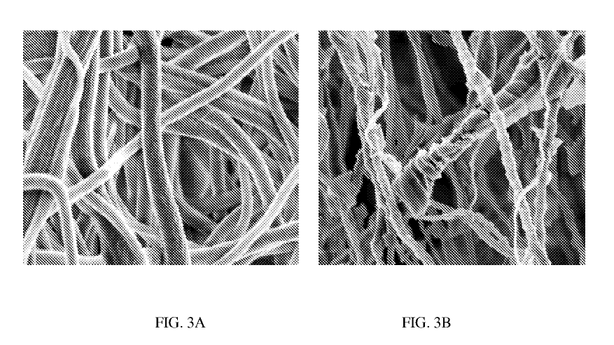

FIG. 3A is a SEM image (60,000 times magnification) of uncoated PEA fiber that is provided for comparison. FIG. 3B is a SEM image (50,000 times magnification) of peptide-coated PEA fiber wherein the peptide coating is prepared as described above in Example 1 by switching the pH of the monomeric peptide solution from pH 8 to pH 6. The self-assembling peptide used for the coating is of SEQ ID NO: 11, as in Example 1 above.

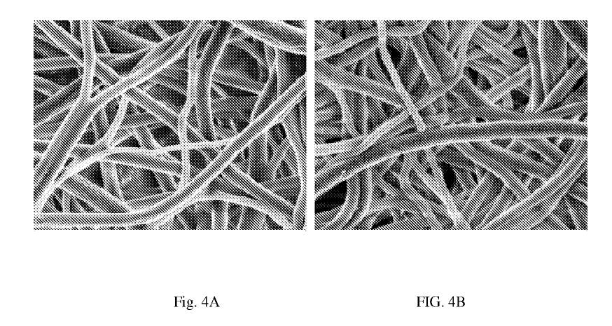

FIG. 4A is a SEM image (60,000 times magnification) of uncoated PEA fiber that is provided for comparison. FIG. 4B is a SEM image (60,000 times magnification) of peptide-coated PEA fiber wherein the peptide coating is prepared as described above in Example 1 by switching the pH of the monomeric peptide solution from pH 8 to pH 4. After preparation, the peptide-coated PEA fiber is immersed in pure (i.e., distilled) water, left for 17.5 hours, to test for dilution rate of the peptide coating when in contact with pure water, then dried. It can be seen from FIG. 4B that most, if not all, of the peptide coating dissolves away, as no peptide coating is seen by SEM. The self-assembling peptide used for the coating is of SEQ ID NO: 11, as in Example 1 above.

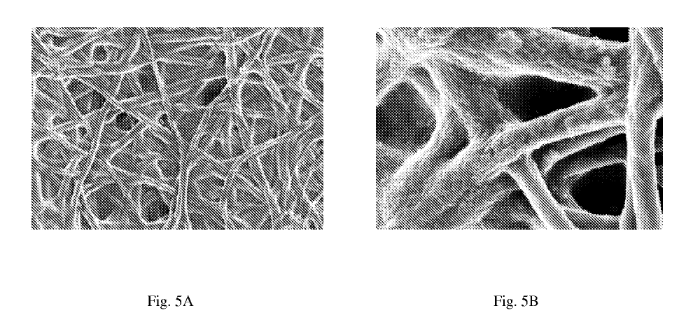

FIGS. 5A and 5B are SEM images (at respective magnifications 15,000 times and 90,000 times) of peptide-coated PEA fiber, which is prepared as described above in Example 1 by switching the pH of the monomeric peptide solution from pH 8 to pH 4. After preparation, the peptide coated PEA is immersed in physiological-like solution (130 millimolar (mM) NaCl in water, pH about 7.4), left for 1 week, to test for dilution rate of the peptide coating when in contact with physiological-like solution, and then dried. The resulting dried peptide-coated PEA fiber is placed in contact with physiological-like solutions to test for dilution rate of the peptide coating thereinto. It can be seen from FIG. 5A that the peptide coating is still visible on the PEA fibers, and thus FIG. 5A seems to show that no significant dissolution of the peptide coating takes place under these conditions. When seen at higher magnification in FIG. 5B, again the peptide coating is still visible on the PEA fibers, but some areas of the PEA fibers seem to have no or very thin peptide coating (see the bottom right-hand corner of the SEM image of FIG. 5B). The self-assembling peptide used for the coating is of SEQ ID NO: 11, as in Example 1 above.

Attempts to sterilize the peptide-coated test sample by contacting it with water at 80° C. or ethanol at room temperature fail; a SEM (not shown) of the resulting material indicates that the fiber(s) comprising the sample partially degrade, perhaps by partial dissolution. Portions of the peptide-coated test sample are found to be sterile, presumably due to contact with chloroform/methanol during the solution-based electrospinning process of Coating-Receptive Fiber Preparation 1.

The information of Example 1 demonstrate that a coating-receptive fiber useful in the present invention is coated with a self-assembling peptide useful in the present invention to provide a peptide-coated fiber of the second embodiment of the present invention, the peptide coating being in reversible operative coating contact with the coating-receptive fiber.

While the invention has been described above according to its preferred embodiments, it can be modified within the spirit and scope of this disclosure. This application is therefore intended to cover any variations, uses, or adaptations of the instant invention using the general principles disclosed herein. Further, the instant application is intended to cover such departures from the present disclosure as come within the known or customary practice in the art to which this invention pertains and which fall within the limits of the following claims.

1. A process of fabricating a peptide-coated fiber, the process comprising (a) contacting a coating-receptive fiber that has a diameter of 10 micrometers (μm) or less to a medium comprising at least one self-assembled peptide polymer and a peptide-coating solvent, wherein the at least one self-assembled peptide polymer is dissolved in the peptide-coating solvent and contacts said coating-receptive fiber, wherein each self-assembled peptide polymer independently comprises two or more self-assembling peptides and each self-assembling peptide is the same or different and independently comprises a self-assembly segment of from 2 to 59 amino acid residues; and (b) allowing the at least one self-assembled peptide polymer to at least partially coat the coating-receptive fiber; wherein the process produces at least one peptide-coated fiber comprising the coating-receptive fiber and a peptide coating, the peptide coating comprising the at least one self-assembled peptide polymer and being in reversible operative coating contact with the coating-receptive fiber.

2. A process of fabricating a peptide-coated fiber of claim 1, the process comprising the steps of:
(i) providing a solution of a fiber-forming material and a solution-electrospinning solvent;
(ii) feeding the solution into an electrospinning device comprising at least one electrode, at least one conductor, a source of voltage, and a collector, wherein the electrode(s) independently is in operative electricity communication with the source of voltage and with the conductor;
(iii) applying a voltage to the device such that the solution of the fiber-forming material and the solution-electrospinning solvent is drawn and a jet is formed from which the solution-electrospinning solvent dissipates to provide a coating-receptive fiber of the fiber-forming material, the coating-receptive fiber having a diameter of 10 μm or less;
(iv) contacting the coating-receptive fiber to a medium comprising at least one self-assembled peptide polymer and a peptide-coating solvent before the coating-receptive fiber contacts the collector, wherein said at least one self-assembled peptide polymer is dissolved in the peptide-coating solvent, wherein each self-assembled peptide polymer independently comprises two or more self-assembling peptides and each self-assembling peptide is the same or different and independently comprises a self-assembly segment of from 2 to 59 amino acid residues and, optionally, one or two supplemental segments each independently comprising 1 or more amino acid residues; and
(v) allowing the at least one self-assembled peptide polymer to at least partially coat the coating-receptive fiber; wherein the solution-electrospinning solvent and the peptide-coating solvent is the same or different and the process produces the at least one peptide-coated fiber.

3. A process of fabricating a peptide-coated fiber of claim 1, the process comprising the steps of:
(i) providing a melt of a fiber-forming material;
(ii) feeding the melt into a melt electrospinning device comprising at least one electrode, at least one conductor, a source of voltage, and a collector, wherein the electrode(s) independently is in operative electricity communication with the source of voltage and with the conductor;
(iii) applying a voltage to the device such that the melt of the fiber-forming material is drawn and a jet is formed to provide a coating-receptive fiber of the fiber-forming material, the coating-receptive fiber having a diameter of 10 μm or less;
(iv) contacting the coating-receptive fiber to a medium comprising at least one self-assembled peptide polymer and a peptide-coating solvent before the coating-receptive fiber contacts the collector, wherein said at least one self-assembled peptide polymer is dissolved in the peptide-coating solvent, wherein each self-assembled peptide polymer independently comprises two or more self-assembling peptides and each self-assembling peptide is the same or different and independently comprises a self-assembly segment of from 2 to 59 amino acid residues and, optionally, one or two supplemental segments each independently comprising 1 or more amino acid residues; and
(v) allowing the at least one self-assembled peptide polymer to at least partially coat the coating-receptive fiber; wherein the process produces the at least one peptide-coated fiber.

4. A process of fabricating a peptide-coated fiber of claim 1, the process comprising the steps of:
(i) providing a melt of a fiber-forming material;
(ii) feeding the melt into a melt blowing device comprising at least one die block having a portion that functions as a die tip, at least one gas knife assembly, a source of a stretch gas stream, and a collector, wherein the source of a stretch gas stream independently is in operative fluid communication with the gas knife assembly and the die tip;
(iii) streaming a stretch gas against the die tip and through the gas knife assembly such that the melt of the fiber-forming material is blown and a jet is formed from the die tip to provide a coating-receptive fiber of the fiber-forming material, the coating-receptive fiber having a diameter of 10 μm or less;
(iv) contacting the coating-receptive fiber to a medium comprising at least one self-assembled peptide polymer and a peptide-coating solvent before the coating-receptive fiber contacts the collector, wherein said at least one self-assembled peptide polymer is dissolved in the peptide-coating solvent, wherein each self-assembled peptide polymer independently comprises two or more self-assembling peptides and each self-assembling peptide is the same or different and independently comprises a self-assembly segment of from 2 to 59 amino acid residues and, optionally, one or two supplemental segments each independently comprising 1 or more amino acid residues; and
(v) allowing the at least one self-assembled peptide polymer to at least partially coat the coating-receptive fiber; wherein the process produces the at least one peptide-coated fiber.

5. A process of fabricating a peptide-coated fiber of claim 1, the process further comprising a first triggering step of triggering assembly of the two or more self-assembling peptides into the at least one self-assembled peptide polymer.

6. A process of fabricating a peptide-coated fiber of claim 5, wherein the first triggering step is performed when the coating-receptive fiber is in contact with the medium.

7. A process according to claim 1, the process further comprising a second triggering step of triggering at least partial coating of the coating-receptive fiber by the at least one self-assembled peptide polymer.

8. A process according to claim 5, wherein each triggering step independently comprises varying concentration of a self-assembling peptide dissolved in the medium; varying pH of the medium; varying ionic strength of the medium; adding one or more peptide-coating solvents to a medium; varying temperature of a medium; varying polarity of a medium; adding a complementary self-assembling peptide; or a combination thereof.

9. A process according to claim 1, the process further comprising a drying step of removing a substantial portion of the peptide-coating solvent from the peptide-coated fiber to give a dried peptide-coated fiber wherein said solvent accounts for less than 10 wt % of said dried peptide-coated fiber.

10. (canceled)

11. (canceled)

12. (canceled)

13. A process according to claim 1, wherein the coating-receptive fiber has a diameter of less than 1000 nanometers (nm).

14. A process according to claim 1, wherein the peptide-coating solvent comprises water, 1,1,1,3,3,3-hexafluoropropan-2-ol, tetrafluoromethane, chloroform, methanol, N,N-dimethylacetamide, N,N-dimethylformamide, tetrahydrofuran, formamide, toluene, 1-propanol, 2-propanol, ethanol, and dichloromethane.

15. A peptide-coated fiber comprising a coating-receptive fiber and a peptide coating, the peptide coating being in reversible operative coating contact with the coating-receptive fiber; wherein the coating-receptive fiber has a diameter of 10 micrometers (μm) or less and the peptide coating comprises at least one self-assembled peptide polymer, wherein each self-assembled peptide polymer comprises two or more self-assembling peptides and each self-assembling peptide is the same or different and independently comprises a self-assembly segment of from 2 to 59 amino acid residues.

16. A peptide-coated fiber according to claim 15, wherein the coating-receptive fiber comprises a polyolefin; polyester; polyamide; poly(ester-amide); poly(ether-amide);
poly(ester-urea); poly(ether-urea); poly(ester-urethane); or poly(ether-urethane).

17. A peptide-coated fiber according to claim 15, wherein the coating-receptive fiber comprises a nylon-6,6 polyamide-6,6; polyurethane; poly(benzimidazole); polycarbonate; poly(acrylonitrile); poly(vinyl alcohol); poly(lactic acid); poly(ethylene-co-vinyl acetate); poly(ethylene-co-vinyl acetate)/polylactic acid; poly(methacrylate)/(tetrahydroperfluorooctylacrylate); poly(ethylene oxide); collagen-poly(ethylene oxide); poly(aniline)/poly(ethylene oxide) blend; poly(aniline)/poly(styrene); silk-like polymer with fibronectin functionality; poly(vinylcarbazole); poly(acrylic acid)-poly(pyrene methanol); poly(styrene); poly(methacrylate); silk/poly(ethylene oxide) blend; poly(vinyl phenol); poly(vinyl chloride); cellulose acetate; a mixture of poly(acrylic acid)-poly(pyrene methanol) and polyurethane; or poly(vinyl alcohol)/silica.

18. A peptide-coated fiber according to claim 15, wherein the coating-receptive fiber comprises a carbon nanotube.

19. A peptide-coated fiber according to claim 15, wherein the coating-receptive fiber has a diameter of less than 1000 nanometers.

20. A peptide-coated fiber according to claim 15, wherein each self-assembling segment independently comprises from 4 to 40 amino acid residues.

21. A peptide-coated fiber according to claim 15, wherein each self-assembling peptide is independently of any one of SEQ ID NOS: 1 to 27.

22. A peptide-coated fiber according to claim 15, at least one self-assembling peptide independently further comprising one or two supplemental segments, each supplemental segment independently comprising 1 or more amino acid residues and being a residual from a protein expression of the self-assembling peptide.

23. An article comprising a peptide-coated fiber of claim 15.


SEQUENCE LISTING (39 sequences)

SEQ ID NO: 1 - protein, 20 aa, Artificial
  Synthetic peptide modelled according to amino acid residues 41-60 of hen lysozyme protein
QATNRNTDGSTDYGILQINS

SEQ ID NO: 2 - protein, 22 aa, Artificial
  Synthetic peptide modelled according to Drosophila Toll receptor TL-LRr1
PALLTDMRNLSHLELRANIEEM

SEQ ID NO: 3 - protein, 21 aa, Artificial
  Synthetic peptide modelled according to amino acid residues 41-61 of hen lysozyme protein
QATNRNTDGSTDYGILQINSR

SEQ ID NO: 4 - protein, 21 aa, Artificial
  Synthetic peptide modelled according to amino acid residues 42-68 of IsK rat kidney potassium channel protein
KLEALWLGFFGFFILGISYIR

SEQ ID NO: 5 - protein, 24 aa, Artificial
  Synthetic peptide modelled according to amino acid residues 42-68 of IsK rat kidney potassium channel protein
KLEALYVLGFFGFFTLGIMLSYIR

SEQ ID NO: 6 - protein, 27 aa, Artificial
  Synthetic peptide modelled according to amino acid residues 42-68 of IsK rat kidney potassium channel protein
KLEALYILMVLGFFGFFTLGIMLSYIR

SEQ ID NO: 7 - protein, 27 aa, Artificial
  Synthetic peptide modelled according to amino acid residues 42-68 of IsK rat kidney potassium channel protein
KLEALYILMVLGFFGFFTLGIMLSYIR

SEQ ID NO: 8 - protein, 27 aa, Artificial
  Synthetic peptide modelled according to amino acid residues 42-68 of IsK rat kidney potassium channel protein
KLEALYILMVLGFFGFFTCGIMLSYIR

SEQ ID NO: 9 - protein, 11 aa, Artificial
  Synthetic peptide that spontaneously assembles into polymer-like beta-tapes
QQRQQQQQEQQ

SEQ ID NO: 10 - protein, 11 aa, Artificial
  Synthetic peptide that spontaneously assembles into polymer-like beta-tapes
QQRFQWQFEQQ

SEQ ID NO: 11 - protein, 11 aa, Artificial
  Synthetic peptide that spontaneously assembles into polymer-like beta-tapes
QQRFEWEFEQQ

SEQ ID NO: 12 - protein, 11 aa, Artificial
  Synthetic peptide that spontaneously assembles into polymer-like beta-tapes
QQXFXWXFQQQ

SEQ ID NO: 13 - protein, 11 aa, Artificial
  Synthetic peptide that spontaneously assembles into polymer-like beta-tapes
QQRFXWXFEQQ

SEQ ID NO: 14 - protein, 11 aa, Artificial
  Synthetic peptide that spontaneously assembles into polymer-like beta-tapes
QQEFEWEFEQQ

SEQ ID NO: 15 - protein, 10 aa, Artificial
  Synthetic peptide that spontaneously assembles into polymer-like beta-tapes
QQXFXWXFXQ

SEQ ID NO: 16 - protein, 11 aa, Artificial
  Synthetic peptide that spontaneously assembles into polymer-like beta-tapes
SSRFEWEFESS

SEQ ID NO: 17 - protein, 11 aa, Artificial
  Synthetic peptide that spontaneously assembles into polymer-like beta-tapes
SSRFXWXFESS

SEQ ID NO: 18 - protein, 37 aa, Artificial
  Synthetic peptide that spontaneously assembles into polymer-like beta-tapes
QQRFQWQFEQGPGGSQFQWQFQSGPGGQEFQWQFRQQ

SEQ ID NO: 19 - protein, 37 aa, Artificial
  Synthetic peptide that spontaneously assembles into polymer-like beta-tapes
QCRFQWQFECGPGGSQFQWQFQSGPGGCEFQWQFRCQ

SEQ ID NO: 20 - protein, 11 aa, Artificial
  Synthetic peptide that spontaneously assembles into polymer-like beta-tapes
EQEFEWEFEQE

SEQ ID NO: 21 - protein, 11 aa, Artificial
  Synthetic peptide that spontaneously assembles into polymer-like beta-tapes
QQXFXWXFXQQ

SEQ ID NO: 22 - protein, 9 aa, Artificial
  Synthetic peptide that spontaneously assembles into polymer-like beta-tapes
QRFQWQFEQ

SEQ ID NO: 23 - protein, 7 aa, Artificial
  Synthetic peptide that spontaneously assembles into polymer-like beta-tapes
RFQWQFE

SEQ ID NO: 24 - protein, 5 aa, Artificial
  Synthetic peptide that spontaneously assembles into polymer-like beta-tapes
FQWQF

SEQ ID NO: 25 - protein, 5 aa, Artificial
  Synthetic peptide that spontaneously assembles into polymer-like beta-tapes
FRWEF

SEQ ID NO: 26 - protein, 3 aa, Artificial
  Synthetic peptide that spontaneously assembles into polymer-like beta-tapes
QWQ

SEQ ID NO: 27 - protein, 3 aa, Artificial
  Synthetic peptide that spontaneously assembles into polymer-like beta-tapes
RWE

SEQ ID NO: 28 - protein, 25 aa, Artificial
  Synthetic
KGARKGAKRQGGKKVARKALKRAGK

SEQ ID NO: 29 - protein, 25 aa, Artificial
  Synthetic
KGGRKGAKRQGGKKLARKALKRAGR

SEQ ID NO: 30 - protein, 21 aa, Artificial
  Synthetic
KGGRKGAKRQGGKKLARKALK

SEQ ID NO: 31 - protein, 21 aa, Artificial
  Synthetic
KGVRKGAKRQGCKKLARKALK

SEQ ID NO: 32 - protein, 20 aa, Artificial
  Synthetic
KGARRGAKRGGKKLARKALK

SEQ ID NO: 33 - protein, 20 aa, Artificial
  Synthetic
KGARRLAKRSGKKVARKAGR

SEQ ID NO: 34 - protein, 20 aa, Artificial
  Synthetic
KFARRLAKRLGKKVARKLGR

SEQ ID NO: 35 - protein, 20 aa, Artificial
  Synthetic
KFLRRLIKRLVKKVLRKLGR

SEQ ID NO: 36 - protein, 16 aa, Artificial
  Synthetic
KAAKKAAKRAAKKATR

SEQ ID NO: 37 - protein, 16 aa, Artificial
  Synthetic
KALKKALKRALKKALR

SEQ ID NO: 38 - protein, 16 aa, Artificial
  Synthetic
KGLKKGLKRGLKKGLR

SEQ ID NO: 39 - protein, 16 aa, Artificial
  Synthetic
KATKKALKRAGKKATR